(19) United States
(12) Patent Application Publication
(10) Pub. No.: US 2026/0253806 A1
(43) Pub. Date: Aug. 27, 2026

(54) MULTILAYER ELECTRONIC COMPONENT

(71) Applicant: SAMSUNG ELECTRO-MECHANICS CO., LTD., Suwon-si (KR)

(72) Inventors: Chae Won BAK, Suwon-si (KR); Chung Eun LEE, Suwon-si (KR)

(73) Assignee: SAMSUNG ELECTRO-MECHANICS CO., LTD., Suwon-si (KR)

(21) Appl. No.: 19/453,907

(22) Filed: Jan. 20, 2026

(30) Foreign Application Priority Data
Feb. 27, 2025 (KR) 10-2025-0025630

(51) Int. Cl. H01G 4/30; H01G 4/232

(52) U.S. Cl. CPC H01G 4/30; H01G 4/232

(57) ABSTRACT

A multilayer electronic component that includes a body having a dielectric layer and internal electrodes alternately arranged in a thickness direction. The body defines first and second surfaces opposing each other in the thickness direction, third and fourth surfaces opposing each other in a length direction and connected to the first and second surfaces, and fifth and sixth surfaces opposing each other in a width direction and connected to the first through fourth surfaces. A pattern is provided on the second surface and includes a first side portion positioned at one end of the second surface in the length direction, a second side portion positioned at the opposite end, and a connection portion extending between the first and second side portions. External electrodes are disposed on the third and fourth surfaces. The widths of the first and second side portions are greater than the width of the connection portion, and the lengths of the first and second side portions are shorter than the length of the connection portion.

### CROSS-REFERENCE TO RELATED APPLICATION(S)

This application claims benefit of priority to Korean Patent Application No. 10-2025-0025630 filed on Feb. 27, 2025 in the Korean Intellectual Property Office, the disclosure of which is incorporated herein by reference in its entirety.

### TECHNICAL FIELD

The present disclosure relates to a multilayer electronic component.

### BACKGROUND

Multilayer ceramic capacitors (MLCCs) are widely used as chip-type condensers mounted on printed circuit boards in a broad range of electronic devices, including image display systems such as liquid crystal displays (LCDs) and plasma display panels (PDPs), as well as computers, smartphones, and other mobile devices. These components have an important role in storing and releasing electrical energy, enabling stable operation of high-performance circuits.

An MLCC typically has a body in which dielectric layers and internal electrodes are alternately stacked in parallel. This layered structure provides the desired capacitance, but also introduces orientation-dependent characteristics. Electrical performance factors such as high-frequency impedance, noise suppression, and overall reliability can vary significantly depending on, for example, whether the mounting surface and the stacking direction of the internal electrodes are aligned parallel or perpendicular to the substrate. Consequently, accurate identification of the stacking direction during assembly is essential to ensure consistent performance.

As devices become smaller and more complex, MLCCs face increased mechanical stress from substrate warpage, thermal cycling, and external impacts. These conditions can lead to cracking and reliability failures, creating demand for solutions that improve flexural strength while simplifying orientation identification. Therefore, there is a need simpler orientation identification that also enhances the mechanical robustness of MLCCs, such as their flexural strength, to withstand bending and impact forces during manufacturing and use.

### SUMMARY

One of the various objects of the present disclosure is to provide a multilayer electronic component in which a stacking direction of an internal electrode is easily distinguished.

One of the various objects of the present disclosure is to provide a multilayer electronic component having improved flexural strength.

The objects of the present disclosure are not limited to the above-described contents, and will be more readily understood when specific embodiments of the present disclosure are described.

According to an embodiment of the present disclosure, a multilayer electronic component includes a body including a dielectric layer and an internal electrode disposed alternately with the dielectric layer in a thickness direction, and including first and second surfaces opposing each other in the thickness direction, third and fourth surfaces connected to the first and second surfaces and opposing each other in a length direction, and fifth and sixth surfaces connected to the first to fourth surfaces and opposing each other in a width direction; a pattern including a first side portion disposed in one end portion of the second surface in the length direction, a second side portion disposed in the other end portion of the second surface in the length direction, and a connection portion connecting the first and second side portions; and an external electrode disposed on the third and fourth surfaces, wherein widths of the first and second side portions are wider than a width of the connection portion, and lengths of the first and second side portions are shorter than a length of the connection portion.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a perspective view of a multilayer electronic component according to an embodiment of the present disclosure.

FIG. 2 is a perspective view of FIG. 1, excluding external electrodes.

FIG. 3 schematically illustrates a cross-sectional view of FIG. 1, taken along line I-I′.

FIG. 4 schematically illustrates a cross-sectional view of FIG. 1, taken along line II-II′.

FIG. 5 schematically illustrates an exploded view of a body.

FIG. 6 is a view corresponding to FIG. 2 according to an embodiment of the present disclosure.

FIG. 7 is a view corresponding to FIG. 2 according to another embodiment of the present disclosure.

### DETAILED DESCRIPTION

Hereinafter, embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinary artisan. Therefore, shapes, sizes, and the like, of the elements in the drawings may be exaggerated for clarity of description, and the elements denoted by the same reference numerals in the drawings may be the same elements.

In addition, in order to clearly illustrate the present disclosure in the drawings, portions not related to the description will be omitted for clarification of the present disclosure, and a thickness may be enlarged to clearly illustrate layers and areas. The same reference numerals will be used to designate the same components in the same reference numerals. Further, throughout the specification, when an element is referred to as “including” or “including” an element, it means that the element may further include other elements as well, without departing from the other elements, unless specifically stated otherwise.

In the drawings, an X-direction may be defined as a first direction, a stacking direction, or a thickness (T) direction, a Y-direction may be defined as a second direction or a length (L) direction, and a Z-direction may be defined as a third direction or a width (W) direction.

### Multilayer Electronic Component

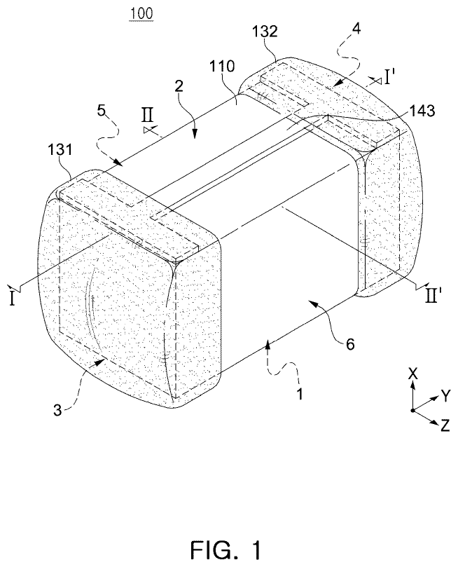

FIG. 1 schematically illustrates a perspective view of a multilayer electronic component according to an embodiment of the present disclosure.

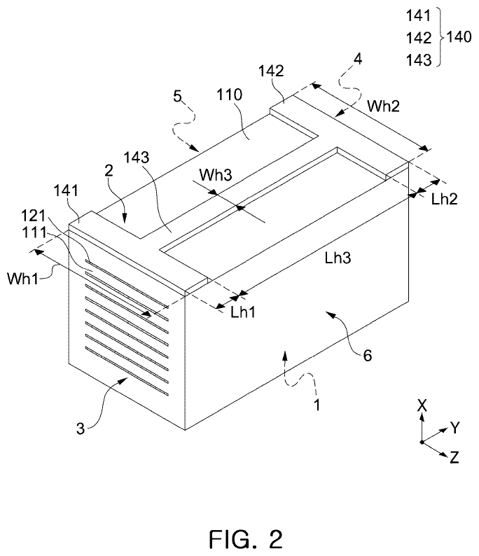

FIG. 2 is a perspective view of FIG. 1, excluding external electrodes.

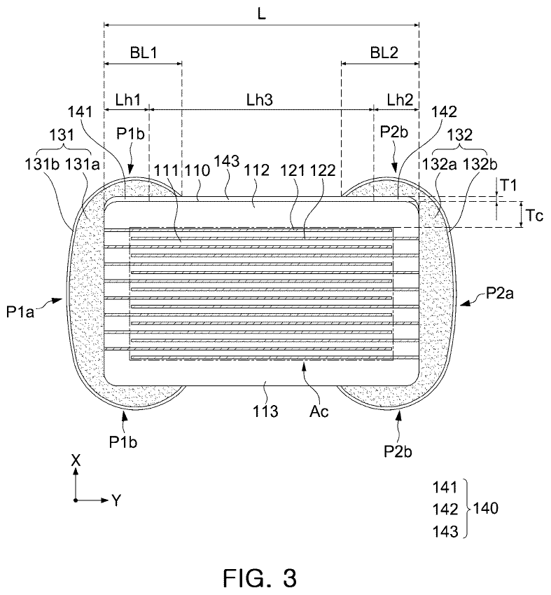

FIG. 3 schematically illustrates a cross-sectional view of FIG. 1, taken along line I-I′.

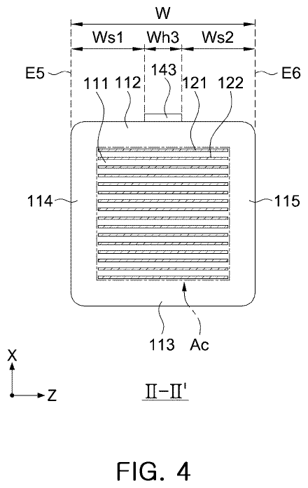

FIG. 4 schematically illustrates a cross-sectional view of FIG. 1, taken along line II-II′.

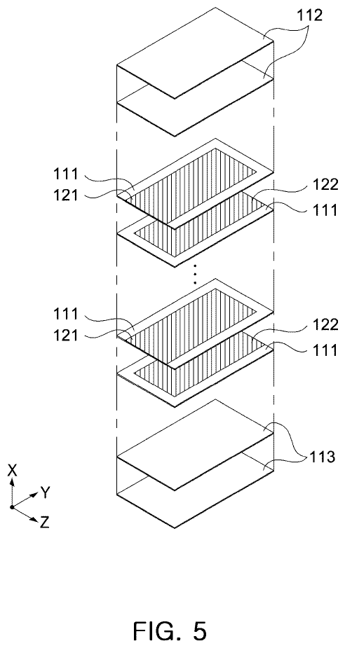

FIG. 5 schematically illustrates an exploded view of a body.

Hereinafter, a multilayer electronic component 100 according to an embodiment of the present disclosure will be described in detail with reference to FIG. 1, FIG. 2, FIG. 3, FIG. 4, and FIG. 5. In addition, a multilayer ceramic capacitor (hereinafter referred to as ‘MLCC’) will be described as an example of a multilayer electronic component, but the present disclosure is not limited thereto, and may be applied to various multilayer electronic components using a ceramic material, such as an inductor, a piezoelectric element, a varistor, a thermistor, or the like.

A multilayer electronic component 100 according to an embodiment of the present disclosure includes a body 110 including a dielectric layer 111 and an internal electrode (121 and 122) alternately disposed in the thickness direction with the dielectric layer, including first and second surfaces 1 and 2 opposing each other in the thickness direction, third and fourth surfaces 3 and 4 connected to the first and second surfaces and opposing each other in the length direction, and fifth and sixth surfaces 5 and 6 connected to the first to fourth surfaces and opposing each other in the width direction; a pattern 140 including a first side portion 141 disposed in one end portion of the second surface in the length direction, a second side portion 142 disposed in the other end portion of the second surface in the length direction, and a connection portion 140 connecting the first and second side portions; and an external electrode (131 and 132) disposed on the third and fourth surfaces, wherein widths Wh1 and Wh2 of the first and second side portions are wider than a width Wh3 of the connection portion, and lengths Lh1 and Lh2 of the first and second side portions are shorter than a length Lh3 of the connection portion.

The MLCC may have a structure in which a dielectric layer and an internal electrode are alternately stacked in parallel in a body thereof, and, since high-frequency impedance, noise, reliability characteristics, or the like may be changed depending on whether a mounting surface and a stacking direction of the internal electrode are in parallel with each other or perpendicular to each other when the MLCC is mounted on a substrate, a method for easily identifying the stacking direction of the internal electrode is necessary. Furthermore, as operating environments for MLCCs become increasingly harsh, there may be a growing demand for improved flexural strength to prevent cracking due to warping of the substrate, external impact, or the like.

Conventionally, a method of performing orientation alignment using a magnet for distinguishing a stacking direction of an internal electrode, or applying a light cover in color to one of an upper cover or a lower cover for distinguishing the stacking direction of the internal electrode and distinguishing a thicker cover between the upper cover and the lower cover, or a method of determining a color using a camera, was used.

However, errors may often occur in the case of performing orientation alignment using a magnet, and poor color recognition may occur even in the case of determining a color using a camera.

Conversely, according to an embodiment of the present disclosure, a pattern 140 may be disposed on a second surface of a body, not only to easily distinguish a stacking direction of an internal electrode, but also to improve bending strength of a multilayer electronic component.

Hereinafter, each configuration included in a multilayer electronic component 100 according to an embodiment of the present disclosure will be described.

A body 110 may include a dielectric layer 111 and an internal electrode (121 and 122), alternately stacked.

Although the specific shape of the body 110 is not particularly limited, the body 110 may have a hexahedral shape or the like, as illustrated. Due to shrinkage of ceramic powder particles included in the body 110 during a sintering process, the body 110 may not have a perfectly straight hexahedral shape, but may have a substantially hexahedral shape.

The body 110 may include first and second surfaces 1 and 2 opposing each other in the thickness direction, third and fourth surfaces 3 and 4 connected to the first and second surfaces 1 and 2 and opposing each other in the length direction, and fifth and sixth surfaces 5 and 6 connected to the first and second surfaces 1 and 2, connected to the third and fourth surfaces 3 and 4, and opposing each other in the width direction.

As a margin region in which the internal electrode (121 and 122) is not disposed overlaps on the dielectric layer 111, a step difference may be generated due to a thickness of the internal electrode (121 and 122), and edges connecting the first surface and the third to fifth surfaces and/or edges connecting the second surface and the third to fifth surfaces may have a shape contracted toward a center of the body 110 in a first direction, based on the first surface or the second surface. Alternatively, due to contraction behavior during a sintering process of the body, edges connecting the first surface 1 and the third to sixth surfaces 3, 4, 5, and 6 and/or edges connecting the second surface 2 and the third to sixth surfaces 3, 4, 5, and 6 may have a shape contracted toward a center of the body 110 in the first direction, based on the first surface or the second surface. Alternatively, to prevent chipping defects or the like, edges connecting each of the surfaces of the body 110 may be rounded by performing a separate process to round the edges, such that the edges connecting the first surface and the third to sixth surfaces and/or the edges connecting the second surface and the third to sixth surfaces may have a round shape.

To suppress a step difference caused by the internal electrode (121 and 122), when the internal electrode is cut to exposed to the fifth and sixth surfaces 5 and 6 of the body after stacking, and then a single dielectric layer or two or more dielectric layers are stacked on both side surfaces of a capacitance formation portion Ac in a third direction (width direction) to form margin portions 114 and 115, there may be no shape in which a portion connecting the first surface and the fifth and sixth surfaces and a portion connecting the second surface and the fifth and sixth surfaces are shrunken.

A plurality of dielectric layers 111 forming the body 110 may be in a sintered state, and a boundary between adjacent dielectric layers 111 may be integrated to such an extent that it is difficult to identify the same without using a scanning electron microscope (SEM). The number of dielectric layers stacked does not need to be particularly limited, and may be determined in consideration of a size of the multilayer electronic component. For example, the body may be formed by stacking 400 or more dielectric layers.

The dielectric layer 111 may be prepared by forming a ceramic slurry containing ceramic powder particles, an organic solvent, and a binder, coating and drying the slurry on a carrier film to prepare a ceramic green sheet, and then sintering the ceramic green sheet. The ceramic powder particles are not particularly limited as long as sufficient capacitance is obtained, but, for example, barium titanate-based (BaTiO₃)-based powder particles may be used as the ceramic powder particles. For more specific examples, the ceramic powder particles may be any one of BaTiO₃, (Ba₁₋ₓCaₓ)TiO₃(0<x<1), Ba(Ti_{1-y}Ca_{y})O₃(0<y<1), (Ba₁₋ₓCaₓ)(Ti_{1-y}Zr_{y})O₃(0<x<1, 0<y<1), or Ba(Ti_{1-y}Zr_{y})O₃(0<y<1).

An average thickness td of the dielectric layer 111 does not need to be particularly limited, but, for example, in a high-voltage MLCC, the average thickness td of the dielectric layer may be 0.2 to 20 μm. However, this is not limited, and the average thickness td of the dielectric layer 111 may be arbitrarily set depending on desired characteristics or purposes.

In this case, the average thickness td of the dielectric layer 111 refers to a size of the dielectric layer 111 located between internal electrodes 121 and 122 in the first direction. The average thickness of the dielectric layer 111 may be measured by scanning cross-sections of the body 110 in the first and second directions using a scanning electron microscope (SEM) at 10,000× magnification. More specifically, an average value may be determined by measuring thicknesses at a plurality of points on a single dielectric layer 111, for example, thirty (30) equally spaced points in the second direction. The thirty (30) equally spaced points may be designated in the capacitance formation portion Ac, which will be described later. In addition, when such an average value is determined by extensively using measurements of average values to ten (10) dielectric layers, the average thickness of the dielectric layer 111 may be more generalized.

The body 110 may include a capacitance formation portion Ac in which the dielectric layer 111 and the internal electrode (121 and 122) are alternately disposed in the thickness direction, and an upper cover portion 112 and a lower cover portion 113, disposed above and below the capacitance formation portion in the thickness direction, respectively.

The capacitance formation portion Ac may be disposed in the body 110, and may include a first internal electrode 121 and a second internal electrode 122 disposed to face each other, with the dielectric layer 111 interposed therebetween, thereby forming capacitance.

In addition, the capacitance formation portion Ac may be a portion contributing to capacitance formation of the capacitor, and may be formed by repeatedly stacking a plurality of first and second internal electrodes 121 and 122 with the dielectric layer 111 therebetween.

The upper cover portion 112 and the lower cover portion 113 may be formed by stacking a single dielectric layer or two or more dielectric layers on upper and lower surfaces of the capacitance formation portion Ac in the thickness direction, respectively, and may basically play a role in preventing damage to the internal electrode due to physical or chemical stress.

The upper cover portion 112 and the lower cover portion 113 may not include the internal electrode, and may include the same material as the dielectric layer 111.

For example, the upper cover portion 112 and the lower cover portion 113 may include a ceramic material, and for example, may include a barium titanate (BaTiO₃)-based ceramic material.

A thickness of the cover portion (112 and 113) need not be particularly limited. For example, the thickness Tc of the cover portion (112 and 113) may range from 20 to 400 μm.

The thickness Tc of the cover portion (112 and 113) may refer to a size in the first direction, and may be an average value of sizes of the cover portion (112 and 113) in first direction, measured at five (5) equally spaced points above or below the capacitance formation portion Ac.

In addition, a margin portion (114 and 115) may be disposed on a side surface of the capacitance formation portion Ac.

The margin portion (114 and 115) may include a first margin portion 114 disposed on the fifth surface 5 of the body 110, and a second margin portion 115 disposed on the sixth surface 6. For example, the margin portions 114 and 115 may be disposed on both end surfaces of the body 110 in the width direction.

As illustrated in FIG. 3, the margin portion (114 and 115) may mean a region between both ends of the first and second internal electrodes 121 and 122 and a boundary surface of the body 110 in the cross-section of the body 110 cut in the width-thickness (W-T) direction.

The margin portion (114 and 115) may basically play a role in preventing damage to the internal electrode due to physical or chemical stress.

The margin portion (114 and 115) may be formed by forming the internal electrode on a ceramic green sheet by applying a conductive paste, except for a region in which the margin portion is formed on the ceramic green sheet.

In addition, to suppress a step difference by the internal electrode (121 and 122), when the internal electrode is cut to exposed to the fifth and sixth surfaces 5 and 6 of the body after stacking, and then a single dielectric layer or two or more dielectric layers are stacked on both side surfaces of the capacitance formation portion Ac in the third direction (width direction) to form the margin portions 114 and 115.

A width of the margin portion (114 and 115) does not need to be specifically limited. To more easily achieve miniaturization and high capacity of the multilayer electronic component, an average width of the margin portion (114 and 115) may be 20 to 400 μm.

The average width of the margin portion (114 and 115) may refer to a third direction average size of a region in which the internal electrode is spaced from the fifth surface, and a third direction average size of a region in which the internal electrode is spaced from the sixth surface, and may also be an average value of third direction sizes of the margin portion (114 and 115) measured at five (5) equally spaced points on a side surface of the capacitance formation portion Ac.

Therefore, in an embodiment, the third direction average sizes of the regions in which the internal electrodes 121 and 122 are spaced from the fifth and sixth surfaces may each be 20 to 400 μm.

The internal electrode (121 and 122) may include first and second internal electrodes 121 and 122. The first and second internal electrodes 121 and 122 may be alternately disposed to face each other, with the dielectric layer 111 forming the body 110 interposed therebetween, and may be exposed through the third and fourth surfaces 3 and 4 of the body 110, respectively.

The first internal electrode 121 may be spaced apart from the fourth surface 4 and exposed through the third surface 3, and the second internal electrode 122 may be spaced apart from the third surface 3 and exposed through the fourth surface 4. A first external electrode 131 may be disposed on the third surface 3 of the body and connected to the first internal electrode 121, and a second external electrode 132 may be disposed on the fourth surface 4 of the body and connected to the second internal electrode 122.

For example, the first internal electrode 121 may not be connected to the second external electrode 132, but may be connected to the first external electrode 131, and the second internal electrode 122 may not be connected to the first external electrode 131, but may be connected to the second external electrode 132. Therefore, the first internal electrode 121 may be formed at a predetermined distance from the fourth surface 4, and the second internal electrode 122 may be formed at a predetermined distance from the third surface 3. In addition, the first and second internal electrodes 121 and 122 may be disposed at a predetermined distance from the fifth and sixth surfaces of the body 110.

A conductive metal included in the internal electrode (121 and 122) may be one or more of Ni, Cu, Pd, Ag, Au, Pt, In, Sn, Al, Ti, and alloys thereof, and the present disclosure is not limited thereto.

A method of forming the internal electrode (121 and 122) is not particularly limited. For example, the internal electrode (121 and 122) may be formed by applying a conductive paste for internal electrodes containing a conductive metal on a ceramic green sheet and sintering the same. As a method of applying the conductive paste for internal electrodes, a screen printing method, a gravure printing method, or the like may be used, but the present disclosure is not limited thereto.

As another example, the internal electrode (121 and 122) may be formed using a sputtering method, a vacuum deposition method, and/or a chemical vapor deposition method.

An average thickness of the internal electrodes does not need to be particularly limited. In this case, a thickness of the internal electrode (121 and 122) may mean a size of the internal electrode (121 and 122) in the first direction. For example, the average thickness of the internal electrode (121 and 122) may be 0.2 to 1.2 μm.

In this case, the average thickness of the internal electrode may be measured by scanning images of cross-sections of the body 110 in the first and second directions with a scanning electron microscope (SEM) at a magnification of 10,000. More specifically, an average value may be determined by measuring thicknesses at a plurality of points on a single internal electrode (121 and 122), for example, thirty (30) equally spaced points in the second direction. The thirty (30) equally spaced points may be designated in the capacitance formation portion Ac. In addition, when such an average value is determined by extensively using measurements of average values to ten (10) internal electrodes 121 and 122, the average thickness of the internal electrodes 121 and 122 may be further generalized.

A pattern 140 may be disposed on the second surface 2 of the body 110. The pattern 140 may include a first side portion 141 disposed in one end portion of the second surface in the length direction, a second side portion 142 disposed in the other end portion of the second surface in the length direction, and a connection portion 140 connecting the first and second side portions, widths Wh1 and Wh2 of the first and second side portions are wider than a width Wh3 of the connection portion, and lengths Lh1 and Lh2 of the first and second side portions are shorter than a length Lh3 of the connection portion. For example, the pattern 140 may have an H shape when observed on the second surface, as illustrated in FIG. 2. Therefore, a stacking direction of the internal electrodes may be easily recognized with naked eyes, and bending strength of the multilayer electronic component may be improved.

In an embodiment, the first and second side portions 141 and 142 may be disposed from a region adjacent to the fifth surface to a region adjacent to the sixth surface.

For example, the first side portion 141 may be disposed to substantially cover one end portion of the second surface in the length direction, and the second side portion 142 may be disposed to substantially cover the other end portion of the second surface in the length direction.

Therefore, a bending strength enhancement effect according to the pattern 140 may be further enhanced, and moisture resistance reliability may be improved by suppressing moisture penetration through edges of the body.

In an embodiment, if a width of the body is W, a width of the first side portion is Wh1, and a width of the second side portion is Wh2, 0.9≤Wh1/W≤1.1 and 0.9≤Wh2/W≤1.1 may be satisfied. For example, the first side portion 141 may be disposed to substantially cover one end portion of the second surface in the length direction, and the second side portion 142 may be disposed to substantially cover the other end portion of the second surface in the length direction. In addition, the first side portion 141 may extend to at least a portion of the third, fifth, or sixth surface, and the second side portion 142 may extend to at least a portion of the fourth, fifth, or sixth surface.

In an embodiment, if a length of the body is L, a length of the first side portion is Lh1, and a length of the second side portion is Lh2, 0.1≤Lh1/L≤0.3 and 0.1≤Lh2/L≤0.3 may be satisfied. Therefore, a bending strength enhancement effect may be sufficiently secured, and bonding strength between the external electrode and the body may be secured.

When Lh1/L and/or Lh2/L is less than 0.1, a bending strength enhancement effect may not be sufficiently secured, and when Lh1/L and/or Lh2/L is greater than 0.3, bonding strength between the external electrode and the body may be insufficient.

In an embodiment, the connection portion 143 may be disposed in a central portion of the second surface in the width direction. In this case, the central portion in the width direction may refer to an intermediate region when the second surface may be divided into three portions in the width direction.

In an embodiment, if a width of the body is W and a width of the connection portion is Wh3, 0.1≤Wh3/W≤0.3 may be satisfied.

When Wh3/W is less than 0.1, it may be difficult to easily recognize the connection portion 143 with the naked eyes, and it may be difficult to implement a shape of the connection portion 143. When Wh3/W exceeds 0.3, there may be a risk that bonding strength between the external electrode and the body is weakened.

A width W of the body 110 may be a width in the Y direction from an extension line E5 of the fifth surface to an extension line E6 of the sixth surface. If a width in the Y direction from the fifth surface of the body 110 to the connection portion 143 is Ws1 and a width in the Y direction from the sixth surface of the body 110 to the connection portion 143 is Ws2, 0.35≤Ws1/W≤0.45 and 0.35≤Ws2/W≤0.45 may be satisfied.

In an embodiment, if a length of the body is L and a length of the connection portion is Lh3, 0.5≤Lh3/L≤0.8 may be satisfied. Therefore, bonding strength between the external electrode and the body may be more easily secured, and a bending strength enhancement effect may be further improved.

In an embodiment, if an average thickness of the pattern 140 is T1, T1 may be 10 μm or greater. Therefore, an identification effect by the pattern may be further improved, and a bending strength enhancement effect may be further improved.

The average thickness of the pattern 140 may be measured from cross-sections cut in the width direction from a center of the multilayer electronic component in the length and thickness directions, or may be an average value of thicknesses measured at five (5) equally spaced points along a central portion of the pattern 140 in the length direction.

In an embodiment, the pattern 140 may include a polymer. Therefore, not only bending strength of the multilayer electronic component may be further improved, but also a shape of the pattern may also be easily formed.

The polymer included in the pattern 140 is not particularly limited. For example, the polymer included in the pattern 140 may be at least one selected from an epoxy resin, an acrylic resin, and an ethyl cellulose. The pattern 140 may further include a fluorescent dye, in addition to the polymer, thereby facilitating identification. Furthermore, the first and second side portions 141 and 142 may include metal particles to have conductivity. Since there is a risk of short circuiting between the first and second external electrodes when the connection portion 143 includes the metal particles, it is preferable that the connection portion 143 does not include the metal particles.

A method for forming the pattern 140 is not particularly limited. For example, the pattern 140 may be formed by applying a paste containing at least one selected from an epoxy resin, an acrylic resin, and an ethyl cellulose in an H shape, on the second surface 2 of the body 110, after a sintering process and before formation of the external electrodes.

The external electrodes 131 and 132 may be disposed on the third and fourth surfaces. The external electrodes 131 and 132 may be disposed on the third and fourth surfaces 3 and 4 of the body 110, respectively, and may include first and second external electrodes 131 and 132 connected to the first and second internal electrodes 121 and 122, respectively. In addition, the first and second external electrodes may be disposed to extend to portions of the first and second surfaces.

Furthermore, the external electrodes 131 and 132 may be disposed to cover both end surfaces of the margin portion (114 and 115) in the second direction.

Although the present embodiment describes a structure in which the multilayer electronic component 100 has two external electrodes 131 and 132, the number and shapes of the external electrodes 131 and 132 may be changed depending on a shape of the internal electrode (121 and 122) or other purposes.

Referring to FIG. 3, the external electrode (131 and 132) may include a first external electrode 131 and a second external electrode 132, and the first external electrode may include a first connection portion P1a disposed on the third surface and a first band portion P1b extending from the first connection portion to portions of the first and second surfaces, and the second external electrode may include a second connection portion P2a disposed on the fourth surface and a second band portion P2b extending from the second connection portion to portions of the first and second surfaces.

In an embodiment, the first band portion P1b may be disposed to cover the first side portion 141, and the second band portion P2b may be disposed to cover the second side portion 142. Therefore, not only bonding strength between the pattern 140 and the body 110 may be improved, but also bonding strength between the external electrode (131 and 132) and the body 110 may be improved, thereby improving reliability. For example, the external electrode (131 and 132) may serve to secure both end portions of the pattern 140. In this case, the external electrode (131 and 132) may be disposed to cover a portion of the connection portion 143.

Since the pattern 140 may include a polymer, the bonding strength with the body may be insufficient. However, according to an embodiment of the present disclosure, the first band portion P1b may be disposed to cover the first side portion 141, and the second band portion P2b may be disposed to cover the second side portion 142, such that bonding strength between the pattern 140 and the body 110 may be improved. In addition, when an end of the first band portion P1b is disposed on the first side portion 141, there may be a concern that bonding strength between the first external electrode 131 and the body 110 may be reduced, and when an end of the second band portion P2b is disposed on the second side portion 142, there may be a concern that bonding strength between the second external electrode 132 and the body 110 may be reduced.

In an embodiment, if a length from the third surface to the end of the first band portion is BL1, a length of the first side portion is Lh1, a length from the fourth surface to the end of the second band portion is BL2, and a length of the second side portion is Lh2, BL1/Lh1≥1.1 and BL2/Lh2≥1.1 may be satisfied. BL1 may be a length in the Y direction from an extension line E3 of the third surface to the end of the first band portion P1b disposed on the second surface, and BL2 may be a length in the Y direction from an extension line E4 of the fourth surface to the end of the second band portion P2b disposed on the second surface.

The external electrode (131 and 132) may be formed using any material that has electrical conductivity, such as metal, and the specific material may be determined in consideration of electrical characteristics, structural stability, or the like, and may further have a multilayer structure.

For example, the external electrode (131 and 132) may include an electrode layer (131a and 132a) disposed on the body 110 and a plating layer (131b and 132b) formed on the electrode layer (131a and 132a).

More specifically, the electrode layer (131a and 132a) may be a sintered electrode including a conductive metal and glass, or a resin-based electrode including a conductive metal and a resin. The conductive metal included in the electrode layer (131a and 132a) may be any material with excellent electrical conductivity, and is not particularly limited. For example, the conductive metal may be one or more of nickel (Ni), copper (Cu), and their alloys.

In an embodiment, the external electrode (131 and 132) may be in contact with the internal electrode (121 and 122), and may include the electrode layer (131a and 132a) including Cu and glass, and the plating layer (131b and 132b) disposed on the electrode layer.

Furthermore, the electrode layer (131a and 132a) may have a form in which the sintered electrode and the resin-based electrode are sequentially formed on the body. In an embodiment, the electrode layer (131a and 132a) may be in contact with the internal electrode (121 and 122), and may include a base electrode layer including Cu and glass, and a conductive resin layer disposed on the base electrode layer and including a conductive metal and a resin.

Furthermore, the electrode layer (131a and 132a) may be formed by transferring a sheet including the conductive metal onto the body, or by transferring a sheet including the conductive metal onto the sintered electrode.

The plating layer (131b and 132b) may serve to improve mounting characteristics. A type of plating layer (131b and 132b) is not particularly limited, and may include one or more of Ni, Sn, Pd, and alloys thereof, and may be formed in plural.

For a more specific example of the plating layer (131b and 132b), the plating layer (131b and 132b) may be an Ni plating layer or an Sn plating layer, and the Ni plating layer and the Sn plating layer may be sequentially formed on the electrode layer (131a and 132a). The Sn plating layer, the Ni plating layer, and the Sn plating layer may be sequentially formed. In addition, the plating layer (131b and 132b) may include a plurality of Ni plating layers and/or a plurality of Sn plating layers.

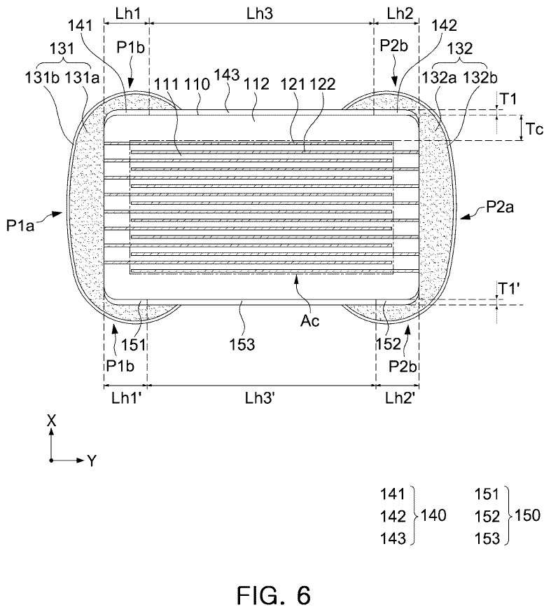

FIG. 6 is a view corresponding to FIG. 2 according to an embodiment of the present disclosure.

Referring to FIG. 6, an additional pattern 150 including a first additional side portion 151 disposed in one end portion of the first surface in the length direction, a second additional side portion 152 disposed in the other end portion of the first surface in the length direction, and an additional connection portion 153 connecting the first additional side portion and the second additional side portion, and including a polymer, may be further disposed.

The additional pattern 150 may have a shape corresponding to a pattern 140, and a length Lh1′ of the first additional side portion may be substantially equal to a length Lh1 of a first side portion, a length Lh2′ of the second additional side portion may be substantially equal to a length Lh2 of a second side portion, and a length Lh3′ of the additional connection portion may be substantially equal to a length Lh3 of a connection portion. In addition, widths and thicknesses of the first additional side portion, the second additional side portion, and the additional connection portion may be substantially the same as widths and thicknesses of the first side portion, the second side portion, and the connection portion.

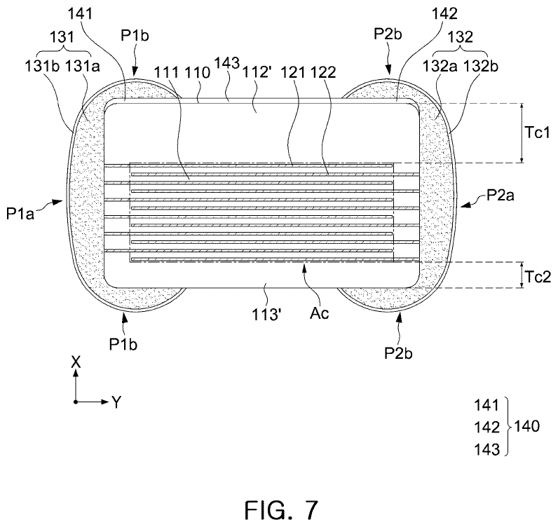

FIG. 7 is a view corresponding to FIG. 2 according to another embodiment of the present disclosure.

Referring to FIG. 7, a body 110 may include a capacitance formation portion Ac in which a dielectric layer and an internal electrode are alternately disposed in the thickness direction, and an upper cover portion 112′ and a lower cover portion 113′, respectively disposed above and below the capacitance formation portion in the thickness direction. If an average thickness of the upper cover portion is Tc1 and an average thickness of the lower cover portion is Tc2, Tc1>Tc2 may be satisfied. When the upper cover portion 112′ thicker than the lower cover portion 113′ is mounted to face a substrate, not only acoustic noise may be reduced, but a pattern 140 may also serve to mitigate impact transmitted from the substrate.

In addition, the expression ‘an embodiment’ used in this specification does not mean the same embodiment, and may be provided to emphasize and describe different unique characteristics. However, an embodiment presented above may not be excluded from being implemented in combination with features of another embodiment. For example, although the description in a specific embodiment is not described in another example, it can be understood as an explanation related to another example, unless otherwise described or contradicted by the other embodiment.

The terms used in this disclosure are used only to illustrate various examples and are not intended to limit the present inventive concept. Singular expressions include plural expressions unless the context clearly dictates otherwise.

As an effect of the present disclosure, a pattern may be disposed on a second surface of a body to easily distinguish a stacking direction of an internal electrode.

As an effect of the present disclosure, bending strength of a multilayer electronic component may be improved.

Various advantages and effects of the present disclosure are not limited to the above-described contents, and will be more readily understood when describing specific embodiments of the present disclosure.

While example embodiments have been shown and described above, it will be apparent to those skilled in the art that modifications and variations could be made without departing from the scope of the present disclosure as defined by the appended claims.

What is claimed is:

1. A multilayer electronic component comprising:
a body including a dielectric layer and an internal electrode disposed alternately with the dielectric layer in a thickness direction, and including first and second surfaces opposing each other in the thickness direction, third and fourth surfaces connected to the first and second surfaces and opposing each other in a length direction, and fifth and sixth surfaces connected to the first to fourth surfaces and opposing each other in a width direction;
a pattern including a first side portion disposed in one end portion of the second surface in the length direction, a second side portion disposed in the other end portion of the second surface in the length direction, and a connection portion connecting the first and second side portions; and
an external electrode disposed on the third and fourth surfaces,
wherein widths of the first and second side portions are wider than a width of the connection portion, and lengths of the first and second side portions are shorter than a length of the connection portion.

2. The multilayer electronic component of claim 1, wherein the first and second side portions are disposed from a region adjacent to the fifth surface to a region adjacent to the sixth surface.

3. The multilayer electronic component of claim 1, satisfying 0.9≤Wh1/W≤1.1 and 0.9≤Wh2/W≤1.1, in which W is a width of the body, Wh1 is a width of the first side portion, and Wh2 is a width of the second side portion.

4. The multilayer electronic component of claim 1, satisfying 0.1≤Lh1/L≤0.3 and 0.1≤Lh2/L≤0.3, in which L is a length of the body, Lh1 is a length of the first side portion, Lh2 is a length of the second side portion.

5. The multilayer electronic component of claim 1, wherein the connection portion is disposed in a central portion of the second surface in the width direction.

6. The multilayer electronic component of claim 1, satisfying 0.1≤Wh3/W≤0.3, in which W is a width of the body, and Wh3 is a width of the connection portion.

7. The multilayer electronic component of claim 1, satisfying 0.5≤Lh3/L≤0.8, in which L is a length of the body, and Lh3 is a length of the connection portion.

8. The multilayer electronic component of claim 1, wherein T1 is 10 μm or more, in which T1 is an average thickness of the pattern.

9. The multilayer electronic component of claim 1, wherein the pattern includes a polymer.

10. The multilayer electronic component of claim 9, wherein the polymer is at least one selected from a group consisting of an epoxy resin, an acrylic resin, and an ethyl cellulose.

11. The multilayer electronic component of claim 1, wherein the external electrode includes a first external electrode and a second external electrode,
wherein the first external electrode includes a first connection portion disposed on the third surface and a first band portion extending from the first connection portion to portions of the first and second surfaces, and
the second external electrode includes a second connection portion disposed on the fourth surface and a second band portion extending from the second connection portion to portions of the first and second surfaces.

12. The multilayer electronic component of claim 11, wherein the first band portion is disposed to cover the first side portion, and the second band portion is disposed to cover the second side portion.

13. The multilayer electronic component of claim 11, satisfying BL1/Lh1≥1.1 and BL2/Lh2≥1.1, in which BL1 is a length from the third surface to an end of the first band portion, Lh1 is a length of the first side portion, BL2 is a length from the fourth surface to an end of the second band portion, and Lh2 is a length of the second side portion.

14. The multilayer electronic component of claim 1, further including an additional pattern including a first additional side portion disposed in one end portion of the first surface in the length direction, a second additional side portion disposed in the other end portion of the first surface in the length direction, and an additional connection portion connecting the first additional side portion and the second additional side portion, and including a polymer.

15. The multilayer electronic component of claim 1, wherein the body includes a capacitance formation portion in which the dielectric layer and an internal electrode are alternately disposed in the thickness direction, and an upper cover portion and a lower cover portion respectively disposed above and below the capacitance formation portion in the thickness direction, and wherein the multilayer electronic component satisfies Tc1>Tc2, in which Tc1 is an average thickness of the upper cover portion, and Tc2 is an average thickness of the lower cover portion.

16. The multilayer electronic component of claim 1, wherein the first and second side portions include a metal particle.
